(19) United States
(12) Patent Application Publication
(10) Pub. No.: US 2024/0351092 A1
(43) Pub. Date: Oct. 24, 2024

(54) WIRE-STRAIGHTENING APPARATUS FOR DIRECTED ENERGY DEPOSITION ADDITIVE MANUFACTURING

(71) Applicant: Nexa3D Inc., Ventura, CA (US)

(72) Inventors: Daniel CAREY, Austin, TX (US); Omar HEGAZY, Long Beach, CA (US); Charles Brandon SWEENEY, Pflugerville, TX (US); Chad EICHELE, Lake Forest, CA (US)

(21) Appl. No.: 18/683,000

(22) PCT Filed: Aug. 11, 2022
(86) PCT No.: PCT/US2022/040081

§ 371 Date: Feb. 12, 2024

Related U.S. Application Data
(60) Provisional application No. 63/231,872, filed on Aug. 11, 2021.

(51) Int. Cl. B21F 1/02; B22F 12/50

(52) U.S. Cl. CPC B21F 1/02; B22F 12/50

(57) ABSTRACT

An apparatus for straightening wire in a directed energy deposition additive manufacturing machine. The apparatus includes at least three roller bearings positioned along one side of a longitudinal axis and a first adjustable bearing and a second adjustable bearing positioned along another side of the longitudinal axis. The first adjustable bearing and the second adjustable bearing are connected to a body and are positioned in a staggered alternating pattern with the at least three roller bearings. Further. the first adjustable bearing and the second adjustable bearing are each configured to apply a load to the wire. A directed energy deposition additive manufacturing machine includes the apparatus. A method for straightening a wire including feeding the wire into the apparatus.

### INTRODUCTION

Additive manufacturing describes processes that form three-dimensional objects by sequentially depositing or solidifying material layer by layer. These processes often involve three-dimensional printing, which utilizes a wide range of materials, such as polymers, metals, and ceramics to form the three-dimensional objects. One such three-dimensional printing process is wire directed energy deposition (DED), which uses metal wire as a feed stock. The metal wire is melted, or semi-melted using an energy source such as electric arc, laser, or electron beam. In addition to forming three-dimensional objects, wire DED may be used to perform local repairs on damaged or worn objects, or for coating or cladding objects in metal. However, there are some challenges in wire feeding, such as using appropriate spool tension and straightening wire exhibiting plastic deformation from spooling prior to printing.

Thus, while current directed energy deposition processes achieve their intended purpose, there is a need for a new and improved system for feeding wire into the directed energy deposition device.

### SUMMARY

According to several aspects, the present disclosure relates to an apparatus for straightening wire in a directed energy deposition additive manufacturing machine. The apparatus includes at least three roller bearings positioned along one side of a longitudinal axis and a first adjustable bearing and a second adjustable bearing positioned along another side of the longitudinal axis. The first adjustable bearing and the second adjustable bearing are connected to a body and are positioned in a staggered alternating pattern with the at least three roller bearings. Further, the first adjustable bearing and the second adjustable bearing are each configured to apply a load to the wire.

In aspects of the above, the first adjustable bearing is connected to a first carrier and the second adjustable bearing is connected to a second carrier. In further aspects, the apparatus further includes a first actuator attached to the first carrier for moving the first carrier relative to the body and a second actuator attached to the second carrier for moving the second carrier relative to the body. In yet further aspects, the first actuator and the second actuator each include a threaded shaft and the first carrier and second carrier each include internal threading, and the first actuator and second actuator each comprise a threaded shaft for engaging the internal threading of the first actuator and the second actuator. In further aspects, the first actuator and second actuator each include a motor for rotating each shaft. And in further aspects, the apparatus further includes a sensor associated with at least one of the first adjustable bearing and the second adjustable bearing, and a controller connected to the sensor and the controller is connected to at least one of the first actuator and second actuator associated with the sensor. And in yet further aspects of the above, the controller is configured to execute the following instructions: determine a need to adjust a position of at least one of the first adjustable bearing and the second adjustable bearing; and provide to at least one of the first actuator and second actuator an instruction to move the carrier associated with the actuator.

In aspects of the above, the first adjustable bearing and the second adjustable bearing are connected directly to the body and the apparatus further comprises an actuator including a wedge slidably attached to the body for moving the first adjustable bearing and second adjust able bearing towards the at least three roller bearings.

In any of the aspects of the above, the apparatus further includes a wear resistant die downstream of the at least three roller bearings, the first adjustable bearing and the second adjustable bearing.

In any of the above aspects, the apparatus is located in a wire feed path between a spool and a directed energy deposition head in the directed energy deposition additive manufacturing machine.

According to several additional aspects, the present disclosure relates to a directed energy deposition additive manufacturing machine. The machine includes a spool for storing a wire, a directed energy deposition head, a feed path between the spool and the directed energy deposition head; and an apparatus for straightening the wire, according to any of the above aspects, the apparatus located in the feed path.

According to several additional aspects, the present disclosure relates to a method of straightening wire in a directed energy deposition additive manufacturing machine. The method includes feeding a wire through an apparatus according to any of the above aspects. The method also includes applying a load to the wire with the first adjustable bearing, applying a load to the wire with the second adjustable bearing, and plastically deforming the wire and straightening the wire.

In aspects of the above, the method further includes drawing down the wire with a wear resistant die after plastically deforming the wire.

In any of the above aspects, the method further includes unspooling the wire before feeding the wire through the apparatus.

According to several aspects, the present disclosure relates to an apparatus for straightening wire in a directed energy deposition additive manufacturing machine. The apparatus includes a heating chamber, through which wire is passable, and a power supply operably coupled to the wire. The apparatus further includes at least two upstream roller bearings positioned upstream of the heating chamber and at least two downstream roller bearings positioned downstream of the heating chamber. The at least two upstream roller bearings and the at least two downstream roller bearings maintain the wire under tension.

In aspects of the above, the heating chamber includes an inert gas inlet proximal to a first end of the heating chamber and an inert gas outlet proximal to a second end of the heating chamber. In further aspects, the apparatus includes an air supply upstream of the heating chamber. And in additional, or alternative aspects, the apparatus includes gas blower downstream of the heating chamber.

In aspects of the above, the power supply is an alternating current generator, and the apparatus further comprises a conductive rod coupled to the power supply. In alternative aspects, the power supply is connected to at least one of the upstream roller bearings and at least one of the downstream roller bearings.

In any of the above aspects, a cooling chamber is located downstream of the heating chamber and upstream of the at least two downstream roller bearings. In further aspects, the cooling chamber includes a cooling gas inlet proximal to a first end of the cooling chamber and a cooling gas outlet proximal to a second end of the cooling chamber.

According to several additional aspects, the present disclosure relates to a directed energy deposition additive manufacturing machine. The machine includes a spool for storing a wire, a directed energy deposition head, and a feed path between the spool and the directed energy deposition head. The machine further includes an apparatus for straightening the wire, according to any of the above embodiments.

According to several additional aspects, the present disclosure relates to a method of straightening wire in a directed energy deposition additive manufacturing machine. The method includes feeding a wire through an apparatus according to any of the above aspects and maintaining the wire under tension between the at least two upstream roller bearings and the at least two downstream roller bearings. The method further includes heating the wire and straightening the wire.

In aspects of the above, the method further includes passing the wire through at least one cooling chamber.

In any of the above aspects, the power supply comprises an alternating current generator connected to a conductive rod, and the method further comprises inducing a current in the wire by applying an alternating current to the conductive rod. Alternatively, the power supply is connected to at least one of the upstream roller bearings and at least one of the downstream roller bearings.

In any of the above aspects, the method further includes heating the wire to a temperature that is equal to or greater than at least one of an annealing temperature and a normalization temperature.

According to several additional aspects, the present disclosure relates to an apparatus for straightening wire in a directed energy deposition additive manufacturing machine. The apparatus includes a first stage of at least two associated roller bearings positioned at a point along an axis, wherein a first of the at least two associated roller bearings is positioned on one side of the axis and a second of the at least two associated rollers bearings is positioned along a second side of the axis, wherein the at least two associated roller bearings are spaced apart a predetermined gap to reduce a diameter of the wire.

In aspects of the above, at least one of the at least two roller bearings is moveable in a direction perpendicular to the axis.

In any of the above aspects, each roller bearing of the at least two roller bearings is attached to a carrier slidably attached to a stand and the carrier is attached to an actuator.

In any of the above aspects, a third roller bearing is associated with the at least two associated roller bearings, wherein the at least two associated roller bearings and the third roller bearing as spaced 120 degrees from adjacent roller bearings.

In aspects of the above, the apparatus further includes a second stage of at least three associated roller bearings positioned at a second point along the axis.

According to several additional aspects, the present disclosure relates to a directed energy deposition additive manufacturing machine. The machine includes a spool for storing a wire, a directed energy deposition head, and a feed path between the spool and the directed energy deposition head. The machine further includes an apparatus for straightening the wire according to any of the above aspects.

According to several additional aspects, the present disclosure relates to a method of straightening wire in a directed energy deposition additive manufacturing machine. The method includes feeding a wire through an apparatus for straightening a wire according to any of the above aspects and applying a load to the wire with the first adjustable bearing, applying a load to the wire with the second adjustable bearing, plastically deforming the wire and straightening the wire, and reducing a diameter of the wire.

In aspects of the above, the first stage includes a third roller bearing associated with the at least two associated roller bearings and the method further comprises feeding the wire through a second stage of at least three associated roller bearings positioned at a second point along the axis.

In any of the above aspects, the method further includes drawing down the wire with a wear resistant die after plastically deforming the wire.

According to any of the above aspects, the method further includes unspooling the wire before feeding the wire through the apparatus.

### BRIEF DESCRIPTION OF THE DRAWINGS

The drawings described herein are for illustration purposes only and are not intended to limit the scope of the present disclosure in any way.

FIG. 1 illustrates an apparatus for straightening wire according to an embodiment of the present disclosure;

FIG. 2 illustrates an apparatus for straightening wire according to an embodiment of the present disclosure;

FIG. 3 illustrates an apparatus for straightening wire according to an embodiment of the present disclosure;

FIG. 4A illustrates an apparatus for straightening wire according to an embodiment of the present disclosure;

FIG. 5 illustrates an apparatus for straightening wire according to an embodiment of the present disclosure;

FIG. 6 illustrates a cross-section of the apparatus for straightening wire of FIG. 5, according to an embodiment of the present disclosure;

FIG. 7 illustrates an apparatus for straightening wire according to an embodiment of the present disclosure;

FIG. 8 illustrates an apparatus for straightening wire according to an embodiment of the present disclosure; and

FIG. 9 illustrates a schematic of a directed energy deposition additive manufacturing machine.

### DETAILED DESCRIPTION

The present disclosure generally relates to a wire-straightening apparatus (“apparatus”) used to straighten wires from 0.1 millimeter (mm) to 1 mm in diameter to aid in the process of feeding a wire to a directed energy deposition print head for additive manufacturing. However, it is contemplated that the apparatus can be used to straighten wires having a diameter that is smaller than 0.1 mm or larger than 1 mm. It is further contemplated that the apparatus can be used to aid in the process of feeding wire to any suitable print head for other methods of manufacturing.

Fine wires or microwires generally come wound on spools with a certain amount of plastic deformation induced into the wire during the manufacturer's spooling process. In order to feed the wire along a pathway to the deposition location, the wire is straightened, both from a radius (cast) and twist (helix) perspective. Minimal bends in the wire can cause jams in the wire feed pathways or conduits, and misalignment of the wire with the laser focal point can cause voids, inconsistencies, incongruities, or other anomalies in bead deposition. Accurately feeding fine wires (0.1-1.0 mm) with a high degree of straightness can be useful for a microwire direct energy deposition system (DED system). The present disclosure relates to methods for high-speed automatic wire-straightening including servo autotuned roller straightening, micro-drawing die-straightening, and electrical resistance-based thermal straightening.

The apparatus can be a component of a microwire feeding subsystem in a directed energy deposition additive manufacturing machine. Microwire from a spool or canister can be unwound and paid out using a set of one or more motorized pinch rollers, belts, hobs, gears, capstans, or other mechanism for gripping and feeding fine wire. More subsystems can control the slack and tension of the wire before or after the payout system. The apparatus can be positioned at a location relative to the motion gantry where the microwire undergoes minimal plastic deformation as the wire makes the final bends in a feed tube to be dispensed at the directed energy deposition head.

In this non-limiting example, the apparatus can make the microwire directed energy deposition printer or other suitable printers a turnkey solution for many customers, because the wire feeding and straightening process is entirely automated. The non-limiting examples disclosed herein enable automated feeding and straightening with quality results and lower complexity for the printer user.

Non-limiting benefits of some examples of the apparatus can include high speed (5 mm/s to 500 mm/s, including all values and ranges therein) wire-straightening for fine wires (0.1 mm to 1.0 mm, including all values and ranges therein) composed of a wide range of metals and alloys with very low (<1%) to very high (>10%) elastic limit strain values. However, the apparatus can include other suitable benefits including wire-straightening at speeds below 5 millimeters per second (mm/s) or above 500 mm/s for wires with diameters that are less than 0.1 mm or diameters that are above 1.0 mm. In addition, the wires can be made of any suitable material with elastic limit strain values above 1% and/or below 10%, including all values in the range of 1 percent to 10 percent.

Non-limiting examples of the apparatus 100 can include a motorized articulating roller 102, an automatically tuned motorized roller, a plastic deformation drawing die, a heated wire straightener, a cold roll cassette, and/or combinations thereof as described in detail below.

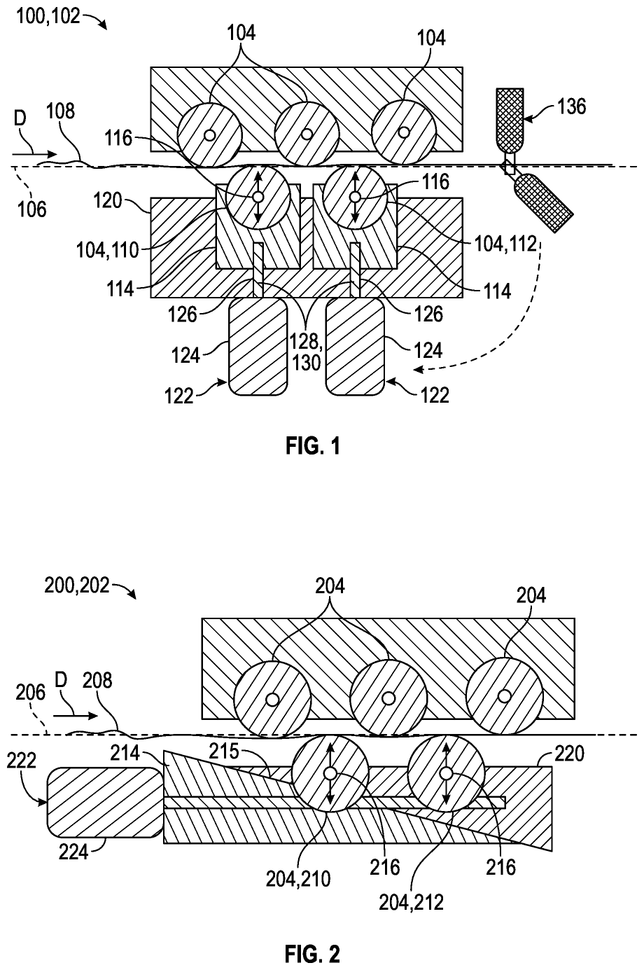

Referring to FIG. 1, one non-limiting example of the apparatus 100 is a motorized articulating roller 102 or a segmented roller bearing wire straightener having three or more grooved roller bearings 104 positioned in a staggered alternating pattern in one or more planes along a longitudinal axis 106. While FIG. 1 illustrates the bearings disposed in one plane along the axis 106 of the wire 108, it is contemplated that other bearings 104 may be similarly positioned in a staggered alternating pattern along the axis 106 in other planes. As the wire 108 moves along the axis 106, in direction D, a first adjustable bearing 110 disposed on one side of the wire 108 engages the wire 108 to apply a load that plastically deforms the wire 108 in a first direction that is perpendicular to the axis 106. Then, as the wire 108 continues to move along the axis 106, a second adjustable bearing 112 disposed on the same side of the wire 108 engages the wire 108 to apply a load that plastically deforms the wire 108 in the same first direction. In the illustrated example, the first bearing 110 is disposed vertically below the wire 108 and engages the wire 108 to apply the load in a vertically upward direction, and the second bearing 112 is disposed vertically below the wire 108 and engages the wire 108 to apply a load in a vertically upward direction. In this way, the wire 108 undergoes progressively smaller deformations at each roller bearing until a predetermined amount of residual cast and helix remain in the wire. In another example (not shown), the second adjustable bearing can be disposed on a second side of the wire 108 for engaging the wire 108 to apply a load that plastically deforms the wire 108 in a second direction, which is opposite to the first direction and perpendicular to the axis 106.

Continuing with the present example, each of the roller bearings 104 is rotatably coupled to a carrier 114 via a post 116. Each carrier 114 can define a slot (not shown), and each post 116 can be a set screw that can be tightened for holding the associated bearing 104 in a fixed linear position along the slot or loosened for moving the associated bearing 104 along the slot. However, it is contemplated that the apparatus can have other fasteners for adjusting the position of each bearing 104 relative to the associated carrier 114.

Also in this example, each carrier 114 can be slidably attached to a body 120, and the apparatus 100 can include one or more actuators 122 that are manually operated for moving the associated carriers 114 relative to the body 120. For instance, the actuator 122 may include a motor 124 operated by a technician and a threaded shaft 126 attached to the motor 124. The threaded shaft 126 engages internal threading 128 disposed within an associated hole 130 formed in the associated carrier 114, such that the carrier 114 and the associated bearing 104 can be moved relative to the body 120 and toward or away from the longitudinal axis 106, in response to the technician operating the motor 124 to rotate the shaft in the associated clockwise and counterclockwise directions. The apparatus 100 can have manual quick-release roller bearings for disengaging from the wire to allow for feeding or removal of the wire from the set of roller bearings 104.

In another example, the apparatus can be an automatic wire feed system for a 3D printing workflow, with actuators moving the roller bearings to engage or disengage from the wire that is fed though the system automatically. Non-limiting examples of the actuator can be a mechanical linear actuator, such as motorized leadscrew, screw jack, ball screw and roller screw actuators. This apparatus can further include a motorized quick release system that can disengage the rollers without operator intervention. Another non-limiting exemplary method would be to use the motorized rollers as described below, with the motorized rollers fully retracting away from the wire to disengage from the same.

It is contemplated that other examples of the apparatus may not have motorized articulating rollers. For example, the motor 124 of FIG. 1 may be replaced with a knob that can be manually turned in either a clockwise direction or a counterclockwise direction by the technician.

Referring to FIG. 2, another example of an apparatus 200 is similar to the apparatus of FIG. 1 and includes the same components identified by the same reference numbers increased by 100. However, while the apparatus 100 of FIG. 1 includes the bearings 104 rotatably mounted to carriers 114 by posts 116, with each carrier 114 being in turn slidably attached to the body 120, the adjustable bearings 210, 212 are slidably attached directly to the body 220 by the posts 116. In addition, while the apparatus 100 of FIG. 1 includes multiple actuators 122 for moving an associated one of the bearings 104, the apparatus 200 includes a single actuator 222 for moving two or more bearings 204. The actuator 222 can include a ramp or wedge 214 slidably attached to the body 220 along a direction that is perpendicular to the axis 106 of the apparatus 200. In this example, the wedge 214 can have a surface 215 that engages the posts 216 for moving the associated post and adjustable bearings 210, 212 toward the axis 206, in response to the motor 224 moving the wedge in a direction parallel to the axis 106. It is contemplated that the apparatus 200 can have one or more return springs (not shown) for moving an associated one of the posts 216 and bearings away from the axis 206.

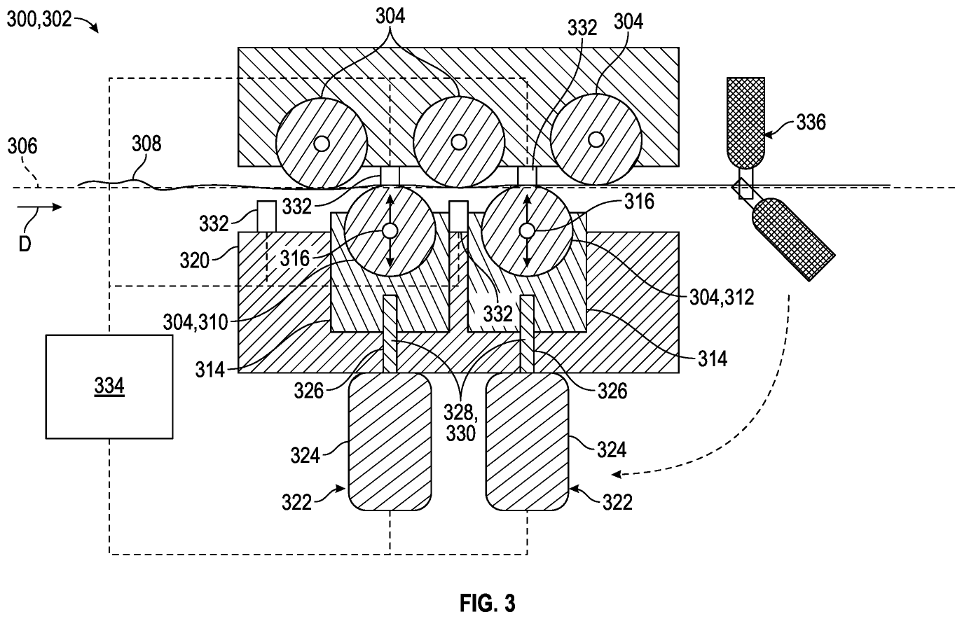

Referring to FIG. 3, another non-limiting example of an apparatus 300 is similar to the apparatus of FIG. 1 and includes the same components identified by the same reference numbers increased by 200. However, while the apparatus 100 of FIG. 1 requires a technician to determine the need to adjust the roller bearings and then operate the motors 124 for adjusting the position of the bearings 104, the apparatus 300 includes one or more sensors 332 for generating detection signals associated with one or more conditions corresponding with a need to adjust the position of an associated roller bearing 304. The conditions include, for example, the wire diameter, variation in wire position in plane 306, variation in the distance of the wire 308 from a given sensor 316, etc. The sensor(s) 316 include, in aspects, proximity sensors, such as an inductive sensor, optical sensor, and capacitive sensor. The apparatus 300 further includes a controller 334 electrically coupled to the sensors 332 for receiving the detection signals from the associated sensors 332. The controller 334 is configured to determine a need to adjust a position of each bearing based on the detection signals, and the controller 334 generates one or more actuation signals in response to the controller determining that there is a need to adjust the position of an associated bearing. One or more actuators 322 move the associated carriers 314 and bearings 304, in response to the actuators 322 receiving the actuation signals from the controller 334.

This exemplary apparatus can be useful for different kinds of metal microwires where more or less roller deformation may be necessary to achieve straightened wire and the process of tuning the rollers manually would be prohibitive.

In another non-limiting example, the apparatus generally straightens wire by inducing an amount of plastic strain or deformation to the wire to counteract or dominate any residual cast or helix in the wire from the spool or feed path history. This can be accomplished by re-bending the wire as in the roller bearing straighteners. However, it is contemplated that another example of the apparatus can draw the wire through a wear resistant die 136 (FIG. 1), 236 (FIG. 2), 336 (FIG. 3) to draw it down to a smaller diameter, thereby inducing a permanent plastic deformation in the wire and straightening it in the process. Wire fed from the spool can have a predetermined diameter that is larger than the desired diameter of the wire received by the print head because draw down will occur in the die drawing and straightening process.

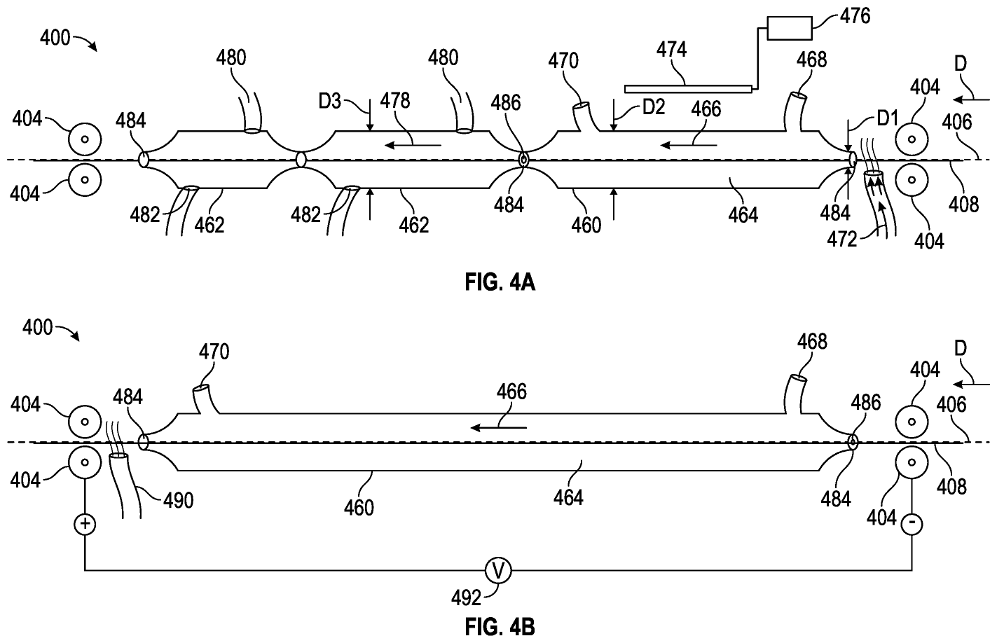

In another example, illustrated in FIGS. 4A and 4B, the apparatus 400 can heat the wire 408 via resistive heating using contact resistive heating, non-contact radio frequency, or inductive heating, through a power supply operably coupled to the wire 408 to provide resistive heating in the wire 408. The same components from FIGS. 1 through 3 are identified by the same reference numbers increasing by 100, 200, and 300 respectively.

Referring to FIG. 4A, an apparatus 400 for straightening a microwire 408 using thermal treatment for a directed energy deposition printer is illustrated. The apparatus 400 heats the wire 408 under tension such that the wire 408 is heated above a temperature where plastic deformation occurs at forces that are lower than the forces required to cause plastic deformation at a lower temperature. The apparatus can heat the wire 408 via conduction, convection, or radiation.

The apparatus includes two or more roller bearings 404 positioned before, upstream of, and after, downstream of, heating and cooling chambers 460, 462, on either side of one or more planes along a longitudinal axis 406. The wire 408 is kept under controlled tension by the roller bearings 404 as it passes through the heating and cooling chambers 460, 462. Additional roller bearings 404 may be provided between the heating chamber 460 and cooling chamber(s) 462. Further, the roller bearings 404 may exhibit an of the features and characteristics described herein relative to the other examples.

The wire 408 moves along the axis 406, in direction D. Prior to entering the heating chamber 460, cold air from an air supply 472 is passed over and around the wire 408. Cold air may be understood as air that exhibits a temperature less than the annealing or normalization temperature of the wire 408 and, in aspects, less than ambient temperature. The wire 408 then enters a first heating chamber or tube 460. The interior volume 464 defined by the heating chamber 460 is shielded using an inert gas 466 fed into the heating chamber 460 through a heating inlet 468 proximal to one end of the heating chamber 460 and released through a heating outlet 470 proximal to other end of the heating chamber 460. The inert gas 466 passes in the direction D of wire 408 movement or, in alternative aspects, passes counter to the direction D of wire 408 movement. In aspects, the inert gas 466 is heated.

In the illustrated aspect, a conductive rod 474 is coupled to a power supply, such as an alternating current (AC) generator 476, and is positioned in proximity to the heating chamber 460 and wire 408. The alternating current generator 476 may be a high voltage AC generator.

High voltage may be understood as exhibiting a voltage of 1 kV or higher, such as in the range of 1 kV to 250 kV, including all values and ranges therein. The conductive rod 474 provides an antenna and induces AC current in the wire 408, heating the wire 408. The wire is heated above a temperature in which plastic deformation occurs at forces that are lower than the forces required to cause plastic deformation at a lower temperature. In aspects, the wire is heated at least to an annealing temperature or a normalizing temperature, which temperature depends on the composition of the wire 408. In aspects, the roller bearings 404, may be grounded.

Once heated in the heating chamber 460, the wire 408 passes through one or more cooling chambers 462, which are positioned downstream of the heating chamber 260. The cooling chamber(s) 462 reduce the temperature of the wire 408 using a cooling gas 478 introduced through a cooling inlet 480 proximal to one end of the cooling chamber 462 and exiting through a cooling outlet 482 proximal to the other end of the cooling chamber 462. The cooling gas 478 passes in the direction D of the wire 408 movement or, in alternative aspects, passes counter to the direction D of the wire 408 movement. The cooling gas 478, in aspects, is an inert gas. Additional cooling chambers 462n may be provided depending on, for example, the rate of cooling that may be desired.

Openings 484 are defined at either end of the heating chamber 460 and cooling chamber(s) 462 exhibit an opening diameter D1 that is less than the diameter D2 of the heating chamber 460 and the diameter D3 of the cooling chamber. In aspects, the opening 484 diameter D1 may be different for each chamber 460, 462 or the same for each chamber 460, 462. In further aspects, the opening may include a seal 486, which seals around the wire 408 in the opening 484, contacting the wire 408 and the openings 484 to reduce seepage of either the inert gas 466 or the cooling gas 478 out of the heating chamber 460 and, in aspects, the cooling chamber 462.

Referring to FIG. 4B, another example of an apparatus 400 for straightening a microwire 408 with resistive heating is illustrated. Similar components are identified by the same reference numbers. Again, the apparatus 400 heats the wire 408 under tension such that the wire 408 is heated above a temperature where plastic deformation occurs at forces that are lower than the forces required to cause plastic deformation at a lower temperature. The apparatus can heat the wire 408 via conduction, convection, or radiation.

The apparatus includes two or more roller bearings 404 positioned before and after heating and cooling chambers 460, 462, on either side of one or more planes along a longitudinal axis 406. The wire 408 is kept under controlled tension by the roller bearings 404 as it passes through the heating and cooling chambers 460, 462. Additional roller bearings 404 may be provided between the heating chamber 460 and cooling chamber(s) 462.

The wire 408 moves along the axis 406, in direction D. The wire 408 enters a first heating chamber or tube 460. The interior volume 464 defined by the heating chamber 460 is shielded using an inert gas 466 fed into the heating chamber 460 through a heating inlet 468 proximal to one end of the heating chamber 460 and released through a heating outlet 470 proximal to other end of the heating chamber 460. The inert gas 466 passes in the direction D of wire 408 movement, or in alternative aspects, passes counter to the direction D of wire 408 movement. In aspects, the inert gas 466 is heated.

In the illustrated aspect, the roller bearings 404 are coupled to a DC or AC power supply 492 and the roller bearings 404 conduct current through the wire 408. In aspects, a negative charge is applied to the roller bearings 404 near the entrance to the heating chamber 460 and a positive charge is applied to the roller bearings 404 near the exit of the heating chamber 460, or vice versa. Alternatively, one set of roller bearings 404 may be grounded. In aspects, the wire 408 is heated to an annealing temperature or to a normalizing temperature, which temperature depends on the composition of the wire 408. Once heated in the heating chamber 460, the wire 408 optionally passes through a cooling gas fed by a gas blower 490. Cooling gas may be understood as gas exhibiting a temperature that is less than the annealing or normalization temperature of the wire 408 and, in aspects, less than ambient temperature. In aspects, the cooling gas is an inert gas. Further, one or more cooling chambers 462 may be provided as described above with reference to FIG. 4A.

Inert gasses described above with reference to FIGS. 4A and 4B protect the wire 408 from oxidation. Inert gasses include, for example, noble gasses such as helium, neon, argon, krypton, xenon, and radon, and in some aspects air, depending on the wire composition. As noted above, the inert gasses may be heated or cooled.

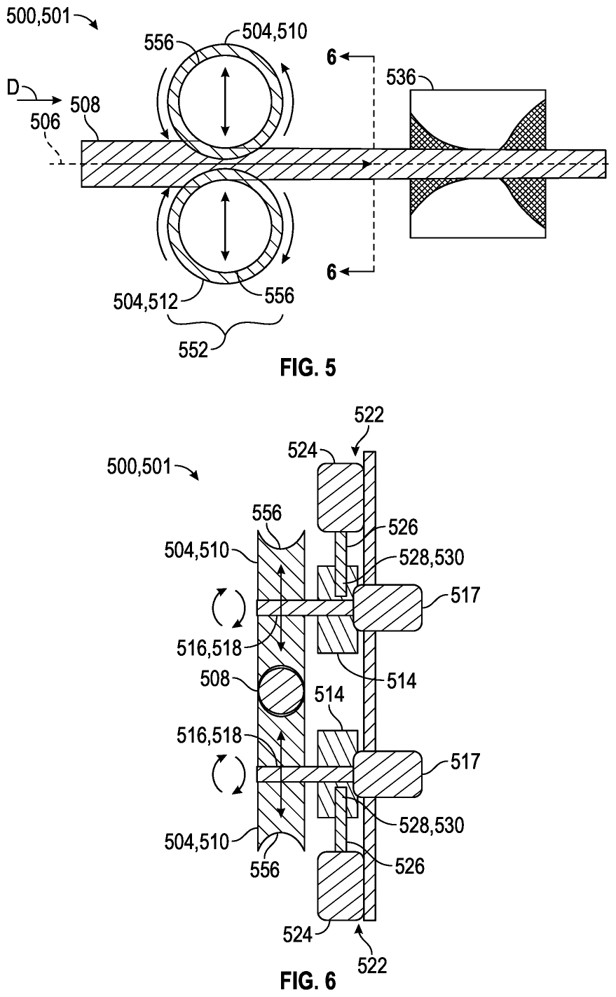

Referring to FIGS. 5 and 6, yet another non-limiting example of an apparatus 500 for straightening a microwire for a directed energy deposition printer is illustrated. While the apparatus 100 of FIG. 1 includes staggered roller bearings 104 that are spaced apart from one another along the axis 106 for applying shear forces to the wire, each pair of roller bearings 504, is positioned at a common point along the axis 506 to apply compressive forces to the wire. The apparatus 500 is a cold roll cassette 501 including one or more stages with one or more pairs of roller bearings 504 to reduce a diameter of a wire 508 and plastically deform the microwire 508 so as to straighten the microwire 508. In this non-limiting example, the roll cassette 501 includes a roll stand 550 (FIG. 6) and a single stage 552 with one pair of roller bearings 504, e.g., first and second roller bearings 510, 512, that are rotatably mounted to the roll stand 550. Each of the first and second roller bearing 510, 512 has a surface 556 for engaging the wire 508 to plastically deform the wire and provide a predetermined cross-sectional shape and/or diameter. For instance, the surface can be concave, and the surfaces of the associated roller bearings 510, 512 can be spaced from one another by a predetermined gap so as to reduce the diameter of a wire from 0.5 mm to 0.45 mm with a circular cross-section. Each of the first and second roller bearings 510, 512 can further include one or ridges (not shown) arranged in a pattern on the surfaces 556 of the roller bearings 510, 512 to form an associated pattern of grooves and/or ridges in the wire 508. Non-limiting examples of benefits provided by these grooves and/or ridges can include more efficient grip on the wire 508 by downstream pinch rollers (not shown) and/or more efficient transfer of heat to and/or from the wire 508. However, it is contemplated that the surface can be flat or concave and/or smooth without any ridges or grooves to plastically deform the wire from any original diameter or thickness by any amount more or less than 0.5 mm.

One or more of the roller bearings 510, 512 can be movable in a direction perpendicular to the axis 506. More specifically, in this non-limiting example, each of the roller bearings 510, 512 is rotatably coupled to a carrier 514 via a post 516. Each carrier 514 can define a slot (not shown) that extends perpendicular to the axis 506, and each post 516 can be a set screw that can be tightened for holding the associated bearing 510, 512 in a fixed linear position along the slot or loosened for moving the associated bearing 510, 512 along the slot. However, it is contemplated that the apparatus can have other fasteners for adjusting the position of each bearing 510, 512 relative to the associated carrier 514 or the stand 550.

It is contemplated that each carrier 514 can be slidably attached to the stand 550, and the apparatus 500 can include one or more actuators 522 that are manually operated for moving the associated carriers 514 relative to the stand 550. For instance, the actuator 522 may include a motor 524 operated by a technician and a threaded shaft 526 attached to the motor 524. The threaded shaft 526 engages internal threading 528 disposed within an associated hole 530 formed in the associated carrier 514, such that the carrier 514 and the associated bearing 510, 512 can be moved relative to the stand 550 and toward or away from the longitudinal axis 506, in response to the technician operating the motor 524 to rotate the shaft 526 in the associated clockwise and counterclockwise directions. The apparatus 500 can have manual quick-release roller bearings for disengaging from the wire to allow for feeding or removal of the wire from the set of roller bearings 504. The apparatus 500 further includes a plurality of drive motors 517 attached to an associated one of the posts 516 for rotatably driving the associated roller bearings 510, 512.

Similar to the apparatus 100 of FIG. 1, the apparatus 500 includes a wear-resistant die 536 to draw it down to a smaller diameter, thereby inducing a permanent plastic deformation in the wire and straightening it in the process.

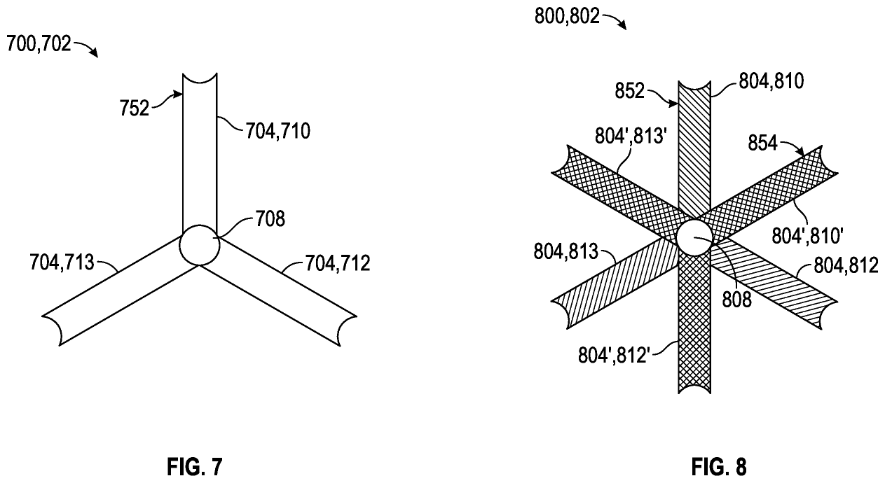

Referring to FIG. 7, another example of an apparatus 700 is similar to the apparatus 500 of FIG. 6 and includes similar components identified by the same reference numbers increased by 200. While the apparatus 500 of FIG. 6 includes a single stage 552 of roller bearings 504 consisting of a pair of roller bearings 510, 512 positioned diametrically opposite to one another relative to the axis 506 at a common point along the axis 506, the apparatus 700 includes a single stage 752 of roller bearings 704 consisting of three roller bearings 710, 712, 713 angularly spaced 120 degrees from one another relative to the axis at one point along the axis 706.

Referring to FIG. 8, another example of an apparatus 800 is similar to the apparatus 700 of FIG. 7 and includes similar components identified by the same reference numbers increase by 100. However, while the apparatus 700 of FIG. 7 includes a single stage 752 of roller bearings 704 consisting of three roller bearings 710, 712, 713 angularly spaced 120 degrees from one another at one point along the axis 406 (see FIG. 5), the apparatus 800 includes first and second stages 852, 854 of roller bearings 804 spaced apart from one another along the axis 506. In this example, the roller bearings 804 of the first stage 852 are angularly spaced from the roller bearings of the second stage 854 by 60 degrees. It is contemplated that the roller bearings 804 of the first and second stages 852, 854 can be angularly spaced from one another by more or less than 60 degrees. It is further contemplated that the roller bearings 804 of the first and second stages 852, 854 can be aligned with one another.

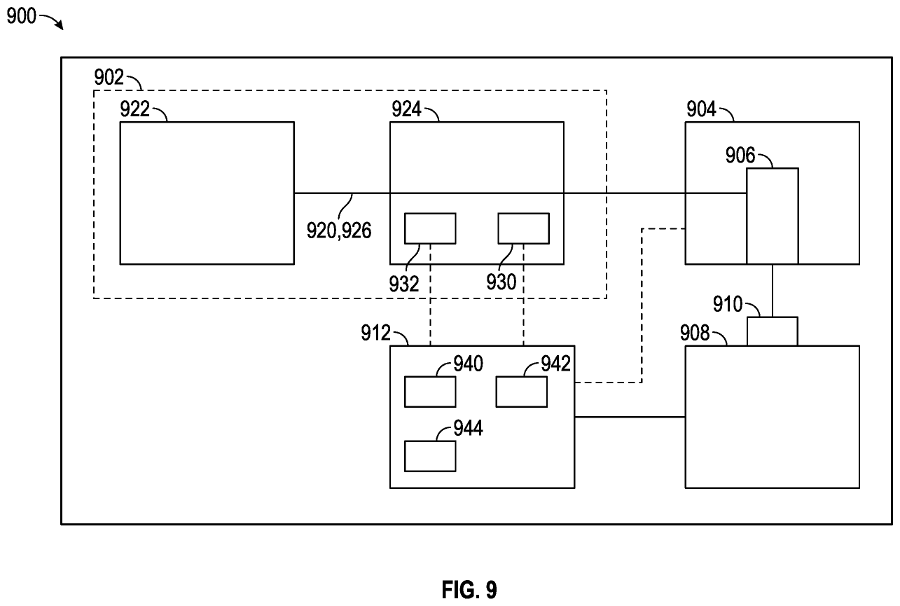

FIG. 9 illustrates a directed energy deposition additive manufacturing machine 900. The directed energy deposition additive manufacturing machine includes a microwire feeding subsystem 902, a motion gantry 904 including a directed energy deposition head 906, a support bed system 908 for supporting a workpiece 910 being formed or otherwise worked on by the directed energy deposition system, and a controller 912, such as the controller 334 illustrated in FIG. 3. As described above, the wire 920 is fed from a spool 922 or canister and is unwound and paid out using a set of one or more motorized pinch rollers, belts, hobs, gears, capstans, or other mechanism for gripping and feeding fine wire. More subsystems can control the slack and tension of the wire before or after the payout system. The apparatus 924, which includes any of the wire-straightening apparatuses 100, 200, 300, 400, 500, 600, 700, 800 described above, is located in the wire feed path 926 between the spool 922 and directed energy deposition head 906, such as between the spool 922 and the motion gantry 904, or within the motion gantry 904. The controller 912, 334 is connected to the one or more actuators 930 located within the apparatus 924 as well as to any sensors 932, such as sensors 316, present in the apparatus 924.

The controller 912 includes one or more processors 940, such as microprocessors, that execute instructions or executable code to control the various functions of the directed energy deposition additive manufacturing machine 900, including the methods further described herein. The instructions are stored in a non-transient memory device 942 accessible to the controller 912, such as random-access memory, read only memory, non-volatile memory, such as flash memory, erasable programmable read only memory, electrically erasable programmable read only memory, digital versatile discs, and compact discs. In aspects, the instructions include g-code and m-code used in depositing the wire 920 as well as instructions for determining a need to adjust a position of at least one of the first adjustable bearing and the second adjustable bearing and providing at least one of the first actuator based on and second actuator an instruction to move the carrier associated with the actuator. The controller 912 may also include interface circuits 944, including wired or wireless interfaces that are connected to a local area network (LAN), the Internet, a wide area network, or combinations thereof.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An apparatus for straightening wire in a directed energy deposition additive manufacturing machine, comprising:
at least three roller bearings positioned along one side of a longitudinal axis; and
a first adjustable bearing and a second adjustable bearing positioned along another side of the longitudinal axis, wherein the first adjustable bearing and the second adjustable bearing are connected to a body, and wherein the first adjustable bearing and the second adjustable bearing are positioned in a staggered alternating pattern with the at least three roller bearings and are each configured to apply a load to the wire.

2. The apparatus of claim 1, wherein the first adjustable bearing is connected to a first carrier and the second adjustable bearing is connected to a second carrier.

3. The apparatus of claim 2, further comprising a first actuator attached to the first carrier for moving the first carrier relative to the body and a second actuator attached to the second carrier for moving the second carrier relative to the body.

4. The apparatus of claim 3, wherein the first actuator and the second actuator each include a threaded shaft and the first carrier and second carrier each include internal threading, and the first actuator and second actuator each comprise a threaded shaft for engaging the internal threading of the first actuator and the second actuator.

5. The apparatus of claim 4, wherein the first actuator and second actuator each include a motor for rotating each shaft.

6. The apparatus of claim 5, further comprising a sensor associated with at least one of the first adjustable bearing and the second adjustable bearing; and a controller connected to the sensor and the controller is connected to at least one of the first actuator and second actuator associated with the sensor.

7. The apparatus of claim 6, wherein the controller is configured to execute the following instructions:
determine a need to adjust a position of at least one of the first adjustable bearing and the second adjustable bearing; and
provide to at least one of the first actuator and second actuator an instruction to move the carrier associated with the actuator.

8. The apparatus of claim 1, wherein the first adjustable bearing and the second adjustable bearing are connected directly to the body and the apparatus further comprises an actuator including a wedge slidably attached to the body for moving the first adjustable bearing and second adjust able bearing towards the at least three roller bearings.

9. The apparatus of claim 1, further comprising a wear resistant die downstream of the at least three roller bearings, the first adjustable bearing and the second adjustable bearing.

10. The apparatus of claim 1, wherein the apparatus is located in a wire feed path between a spool and a directed energy deposition head in the directed energy deposition additive manufacturing machine.

11. A method of straightening wire in a directed energy deposition additive manufacturing machine, comprising:
feeding a wire through an apparatus including at least three roller bearings positioned along one side of a longitudinal axis, and a first adjustable bearing and a second adjustable bearing positioned along another side of the longitudinal axis, wherein the first adjustable bearing and the second adjustable bearing are connected to a body, and wherein the first adjustable bearing and the second adjustable bearing are positioned in a staggered alternating pattern with the at least three roller bearings and are each configured to apply a load to the wire;
applying a load to the wire with the first adjustable bearing;
applying a load to the wire with the second adjustable bearing; and
plastically deforming the wire and straightening the wire.

12. The method of claim 11, further comprising drawing down the wire with a wear resistant die after plastically deforming the wire.

13. The method of claim 11, further comprising unspooling the wire before feeding the wire through the apparatus.

14. A directed energy deposition additive manufacturing machine, comprising a spool for storing a wire;
a directed energy deposition head;
a feed path between the spool and the directed energy deposition head; and
an apparatus for straightening the wire, the apparatus located in the feed path including:
at least three roller bearings positioned along one side of a longitudinal axis, and a first adjustable bearing and a second adjustable bearing positioned along another side of the longitudinal axis, wherein the first adjustable bearing and the second adjustable bearing are connected to a body, and wherein the first adjustable bearing and the second adjustable bearing are positioned in a staggered alternating pattern with the at least three roller bearings and are each configured to apply a load to the wire.
